(19) United States
(12) Patent Application Publication
(10) Pub. No.: US 2014/0159389 A1
(43) Pub. Date: Jun. 12, 2014

(54) BI-MATERIAL DEVICE FOR TEMPORARILY CLOSING AN OPENING MEMBER ON A STATIONARY MEMBER OF A MOTOR VEHICLE BODY

(71) Applicant: Stéphane Perche, Saint Bardoux (FR)

(72) Inventor: Stéphane Perche, Saint Bardoux (FR)

(73) Assignee: EXSTO THERMOPLASTICS, Romans sur Isere (FR)

(21) Appl. No.: 14/234,508

(22) PCT Filed: Jul. 12, 2012
(86) PCT No.: PCT/FR2012/051652

§ 371 Date: Jan. 23, 2014

(30) Foreign Application Priority Data
Jul. 29, 2011 (FR) 11/56968

(51) Int. Cl. E05C 21/00

(52) U.S. Cl. CPC E05C 21/005
USPC 292/288

(57) ABSTRACT

A device temporarily closes an openable body section on a stationary element of automobile body, wherein a recess is provided in the openable body section or in the stationary element, said device including a body with an anchoring unit configured to anchor onto the stationary element or onto the openable body section, and including a retaining unit to keep the openable body section in an intermediate position, wherein the retaining unit consists of an elastic tab capable of bending under stress exerted by a first edge of the recess during the movement of the openable body section from a free open position to the intermediate position, wherein the free end is made of a polymeric material, with a hardness between 90 on the Shore A scale and 60 on the Shore D scale, and a tear strength, as measured according to the ISO 34-1 standard, is higher than 70 kN/m.

The present invention relates to a device for temporary closing an opening member on a stationary member of a motor vehicle body.

The motor vehicle production lines include bodywork painting lines fitted with openings, and particularly doors.

These openings are not yet equipped with their permanent closing devices or locks, and it is therefore necessary to provide temporary and removable closing devices which make it possible to maintain the openings in an intermediary closure position on the body during its transfer on the painting line.

In the past, temporary closing devices mounted in place of the permanent lock by means of fixing members, such as for example screws, were proposed.

These devices are formed by metal components which have a shelf life at least equal to the time required for the manufacture of the vehicles on which they are used. However, the metal components may damage the body and/or paint when they are installed or removed, and must regularly undergo various cleaning treatment, whereof the frequency depends on the speed at which they are fouled with every passage in the painting lines. Moreover, after such cleaning, the temporary closing devices are subjected to a compliance upgrade on a control template.

It is known a temporary closing device of an opening member on a stationary member such as illustrated in document EP 931 895 B1, overcoming the previous drawbacks, of simple and economical design, not requiring any fixing members, thereby making possible a greater ease and higher speed in the installation and removal of the device.

However, the drawback of the temporary closing device according to this document is that it comprises a tab forming a means for retaining the opening member which is subjected to high stress and deformation during the closing of the opening member on the stationary member.

The stress to overcome during this closure is important. However, when the opening member comes into contact with the tab and forces the latter to withdraw, the occurring friction may chip off the layer(s) of paint applied to the opening member and/or abrade the tab itself.

Furthermore, after several manipulations of the opening member, plastic or metal dust, from the temporary closing device itself, especially the tab, or the body, may be deposited on the body, and constitute permanent visual defects once they are covered by a layer of paint.

In fact, when the vehicle is transferred to the cabin or the oven, this dust is conveyed by the ventilated air and is randomly re-deposited on the bodywork under the effect of gravity. This produces grains that are harmful to the outer aspect of the finished vehicle in the form of foreign bodies under the subsequent layers of paint film.

In order to avoid this and meet the quality criteria in terms of paintwork, car manufacturers are required to remove these grains by localized sanding and apply a new coat of paint. These meticulous operations really complicate the body paintwork process and increase the cost thereof.

Therefore, manufacturers seek at all costs to remove this visual imperfection both on the opening member and the stationary member, as it results in a very high bodywork recycling rate and generates additional car manufacturing costs.

The purpose of the invention is to provide a solution to overcome the drawbacks detailed above which is especially suitable to prevent the production of grains during the car body painting operations.

To this end, the invention relates to a temporary closing device of an opening member on a stationary member of a body of a motor vehicle, a housing being preserved in the opening member or the stationary member, said device comprising a body:
which is fitted with means for anchoring on the stationary member or the opening member, and
which comprises a retaining means designed to maintain the opening member in an intermediary closure position with respect to the stationary member,
the retaining means being formed by an elastic tab capable of bending under the stress exerted by a first edge of the housing edge on a free end of the tab when the opening member moves from a free opening position to the intermediary closure position,

said device being characterized in that at least the free end portion which is in contact with the first edge during said movement is made of a polymeric material whereof the hardness ranges between 90 shore scale A and 60 shore scale D and whereof the tear resistance measured according to 34-1 ISO standard is higher than 70 kN/m.

The inventors of the present invention have found, quite surprisingly, that with the technical features of the polymeric material detailed above from which is formed the end portion of the tab in contact with the edge of the opening member, the temporary closing device according to the invention does not generate dust during paintwork operations. The formation of grains is thus avoided, which is quite advantageous for motor vehicle body paintwork.

The temporary closing device according to the invention exhibits strong properties of elasticity and resistance to the stress exerted by the opening member during its movement, since its body can be made without difficulty from a plastic material conventionally used for this type of temporary closing device.

Typically, it consists of polyamide 6-6 which also has the advantage of being resistant to high temperatures, such as those which the body of a motor vehicle is exposed to during the curing of a coat of paint (of the order of 180° C.)

Furthermore, compared to known temporary closing devices, the temporary closing device according to the invention has the advantage that the body portion in contact with the edge—optionally cutting—of the opening member is “preserved” and remains intact, as it is made of a suitable polymeric material which is resistant to friction which generates unwanted particles. In other words, this polymeric material has strong abrasion resistance.

The temporary closing device according to the invention is advantageously bi-material.

The temporary closing device according to the invention further has the advantage that it can be installed according to the methods conventionally used for mounting such a temporary closing device. In fact, it is positioned at the same location on the motor vehicle, using the same tools and within an assembly time equivalent to that of temporary closing devices of this type. In other words, use of the temporary closing device according to the present invention fits perfectly well in the assembly line, and thus, without any modification in the assembly method.

In one embodiment of the invention, said portion of the free end of the tab made of the polymeric material described above forms a protruding nose over a length ranging between one quarter and half the length of the tab.

Advantageously, this portion of the free end of the tab is obtained by overmolding on the tab.

According to an embodiment of the invention, half the free end of the tab is made by overmolding said polymeric material on the tab.

Depending on the overmolding moulds, its scope and the technicality of the moulding method used, the skilled person can decide which portion of the temporary closing device according to the invention is suitable to overmold in the polymeric material exhibiting the technical features described above.

Preferably, the hardness of the polymeric material ranges between 90 Shore scale A and 97 Shore scale A.

In a preferable manner, the tear resistance of the polymeric material is higher than 80 kN/m, even more preferably, it is higher than 90 kN/m.

The polymeric material such as described above advantageously has a melting point temperature higher than 170° C., preferably higher than 180° C. In this manner the polymeric material is resistant to an exposure at 180° C. which is the typical temperature at which the bodies are subjected during motor vehicle body painting operations in the drying tunnels.

The polymeric material may be selected from the group consisting of elastomers, thermoplastic and thermosetting elastomers.

In a preferred manner, the polymeric material is selected from the group consisting of polyurethane thermoplastic elastomers, styrenic thermoplastic elastomers and polysiloxanes.

Overmolding can be achieved by an injection, dipping or spraying method. The hold of the molding can be ensured by chemical bonding or mechanical grip. Of course, the molding techniques are well within the reach of the skilled person.

According to other features of the device according to the invention:
The device further comprises an abutment intended to cooperate with a second edge of the housing during the movement of the opening member from the free opening position to the intermediary closure position.
The body is extended in its area substantially corresponding to the base of the tab by a plate suspended above a recessed area, the plate and the tab being connected by an arch ensuring a flexible connection.
The arch is connected to the tab substantially in its middle, and to the plate substantially at its free end.
The arch is connected to the tab substantially in its middle, and to the plate substantially at its free end.
The plate is rotated in an opposite direction to the first end of the device.
The tab and the plate form an acute angle.
The tab, the plate and the arch are integrally formed with the body of the device.
The protruding nose is located at the end of the tab.
The thickness of the protruding nose is less than 2 mm.
The tab comprises at its base a recessed portion.
The abutment comprises a means for absorbing shocks due to contact with the first edge of the opening member when it is closed on the stationary member.
The absorption means is made up of a portion of material suspended with respect to the body so as to be able to deform locally under the stress of the first edge of the opening member.
An opening is preserved in the body of the device passing therethrough from end to end.
The body comprises below its lower side a plate extending on either side of the body and perpendicularly to this body, the lower surface of the plate being fitted with a plurality of pads preserving a space between the plate and the corresponding supporting surface of the stationary member.
The pads have a length of the order of 1 mm, preserving an equivalent space between the plate and corresponding supporting surface of the stationary member.
The pads are distributed over the periphery of the lower surface of the plate.
The body of the device comprises an attachment cavity allowing the passage and retention of a rigid wire at one of its ends, the wire being capable of holding at its other end the opening member in a half-open position.
The body comprises a pin helping to ensure the fixing thereof to the stationary member, by insertion into the tapped orifice, the cavity crossing through the pin along its longitudinal axis.

Other features and advantages of the invention will become apparent upon reading the following description and with reference to the accompanying drawings, in which:

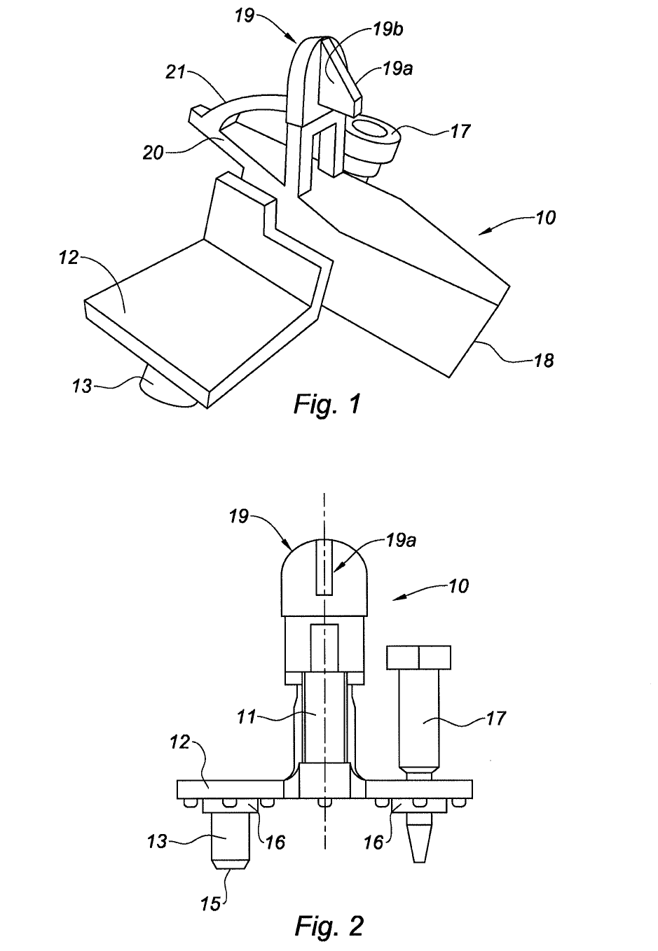

FIG. 1 is a perspective view of the temporary closing device according to the invention.

FIG. 2 is a front view of the temporary closing device according to the invention.

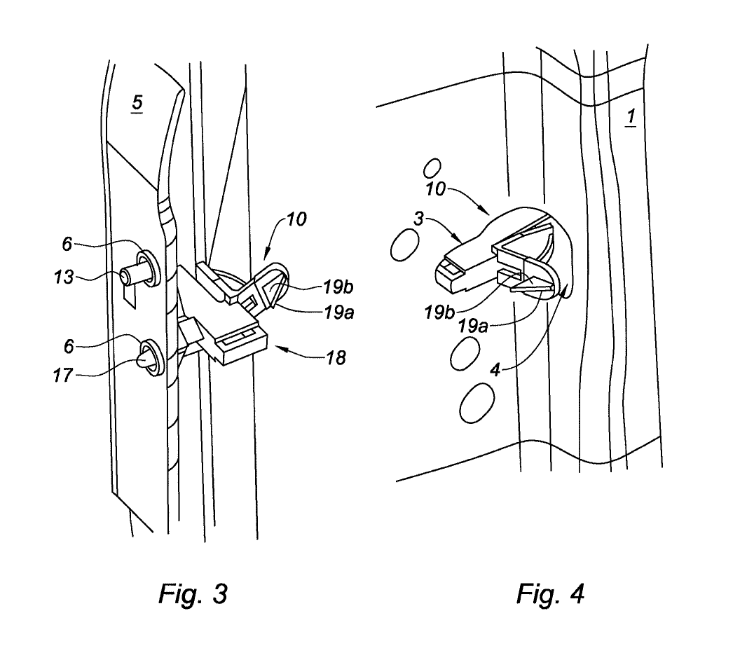

FIG. 3 is a perspective view of the temporary closing device according to the invention, mounted on the stationary member.

FIG. 4 is a schematic perspective view of the temporary closing device according to the invention against which the opening member is in abutment with, and the opening member being in an intermediary closure position.

As shown in FIG. 4, the opening member 1, consisting of a door, comprises a housing 2 intended to receive a lock. The housing 2 is formed by a cut-out formed on the inner side of the opening member 1 and particularly comprises an edge 3, extending perpendicularly to the plane of the opening member 1, and an edge 4, extending in parallel to the plane of said opening member 1. These edges 3 and 4 are intended to cooperate with the temporary closing device 10.

As shown in FIG. 3, the stationary member 5 comprises two tapped and parallel orifices 6.

Furthermore, the stationary member 5 comprises in the axis of each tapped orifice 6 a recess (not shown in FIG. 3).

The temporary closing device 10 shown in the figs. comprises a one-piece body 11 made of polyamide 6-6, fitted with anchoring means (detailed below) in the tapped orifices 6, which includes an abutment 18 intended to cooperate with the edge 3 of the housing 2, when the opening member 1 is closed, and a retaining means in the form of a tab 19 of the opening member 1 in its intermediary closure position against the stationary member 5, and which is intended to penetrate inside the housing 2 behind the edge 4.

The tab 19 exhibits a flat protruding nose 19a, perpendicular to the plane of the tab 19, turned towards the abutment 18. The protruding nose 19a cooperates in contact by its slot 19b with the edge 4 of the housing 2 when the opening member 1 is moved from its free opening position to its intermediary closure position.

The area of contact, during the movement of the opening member 1, is almost punctual, thus facilitating the sliding of the edge 4 and damaging the least paint possible, when the device 10 is already coated with paint and t is once again brought into contact with the opening member 1 when the latter is closed anew.

More importantly, half of the free end of the tab 19, whereof the protruding nose 19a, has been made by overmolding on the tab 19 with polyester-type thermoplastic polyurethane. Thus, through this appropriate polymeric material, the protruding nose 19a is protected and is not planed by the edge 4 of the opening member 1 when it moves from its free opening position to its intermediary closure position. In this manner, the movement of the opening member 1 does not generate any dust from the materials, cause of the formation of grains during motor vehicle body painting operations.

The body 11 comprises a plate 12 extending on either side of the body 11 and perpendicularly to this body 11, thereby forming side wings intended for fixing the device 10 on the stationary member.

The means for anchoring the temporary closing device 10 onto the stationary member 5 comprise fixing members formed, on the one hand, by a pin 13 arranged beneath the plate 12, and, on the other hand, by a screw 17 integral with the body 11 of the device 10 and connected thereto by spurs (captive screw). The screw 17 is substantially located above the plate 12, ready to be threaded and to pass through the plane of the plate 12. The pin 13 and the screw 17 are arranged substantially parallel, each on a corresponding wing of the plate 12 and separated by the body 11.

The pin 13 and the screw can be arranged at the ends of the side wings of the plate 12.

The pin 13 has at its free end a centring cone 15 in the corresponding tapped orifice 6, or a rounded surface 20 having the same effect. Likewise, the screw 17 has at its tip a centring cone or a rounded surface for the same purpose.

The anchoring means also comprise interlocking members in the recesses which are not shown and are made up of two shoulders 16, each arranged below the plate 12 in the corresponding axis of the pin 13 and the screw 17.

The pin 13 may be either entirely cylindrical or semi-cylindrical. As shown in FIG. 3, the pin 13 is semi-cylindrical.

The elastic tab 19 extends above the body 11 at an inclination of the order of 15 and 30° with respect to the vertical plane defined by the axes of the pin 13 and the screw 17 (FIG. 1). The inclination of the tab is defined in an opposite direction to the abutment 18 of the device 10.

The body 11 of the device 10 is extended in its area substantially corresponding to the base of the tab 19, by a plate 20, parallel to the plate 12, suspended above a recessed area.

This plate 20 constitutes a secondary tab intended to take on some of the stresses and deformation of the tab 19.

To this end, the edge 19 and the plate 20 are connected by an arch 21 ensuring a flexible connection. The arch 21 is connected to the tab 19 in its middle, and the plate 20 at its free end. The bending of the tab 19 is all the more restricted that stresses and deformation are distributed over the various portions of the device 10.

Before the passage through the paint line of the body whereon the opening members 1 have previously been mounted, the stationary members 5 of this bodywork intended to receive the opening members 1 when they are being closed, are each equipped with a temporary closing device 10.

For this purpose, the operator engages the centring cones 15 of the pin 13 into the corresponding tapped orifice 6 of the stationary member 5 and exerts pressure on the body 11 such that, on the one hand, the pin 13 penetrates into a tapped orifice 6 and, on the other hand, each shoulder 16 fits into the recess (not shown in the fig.) preserved on the stationary member 5.

Preferably, the recesses (not shown in the fig.) have a square shape and the shoulders 16 have a cylindrical shape.

The operator first engages the pin 13 into the corresponding tapped orifice 6 and then this operator screws the screw 17 into the other tapped orifice 6.

During the closing of the opening member 1 manually or automatically, the edge 3 of the housing 2 preserved in this opening member 1 is gradually brought into contact with the abutment 18 of the device 10 by overlapping the body 11 of the latter, thus ensuring an automatic adjustment of the body 11 with respect to the housing 2.

Then, by continuing to exert pressure on the opening member 1, the edge 4 of the housing 2 makes the tab 19 bend, such that this edge 4 passes behind said tab 19.

Furthermore, the edge 3 of the housing 2 is pressed against the abutment 18 of the body 11.

Then, the tab 19 returns to its initial position, due to its elasticity, and ensures the blocking of the edge 4, and consequently of the opening member 1.

In order to increase the locking force of the opening member on the stationary member 5 by the temporary closing device 10, the stiffness of the elastic tab 19 should be increased. In other words, the dimensions of width, thickness and length of the tab 19 need to be adapted so that it has the appropriate stiffness.

During the opening of the opening member 1 which can be done manually or automatically, the elastic tab 19 bends in a reverse direction such as to let pass this edge 4 thus allowing the opening member 1 to be opened.

To remove the temporary closing device 10 from the stationary member 5, the operator first unscrews the screw 17 and then pulls on the body 11 so as to cause the pin 13 to leave the tapped orifice 6.

The temporary closing device according to the invention avoids damage to the paint and/or the vehicle body during its installation or removal. Thanks to this temporary closing device, grains are not generated during the motor vehicle body painting operations.

1. Temporary closure device of an opening member on a stationary member of a body of a motor vehicle, a housing being arranged in the opening member or in the stationary member, said device comprising a body:
which is fitted with means for anchoring on the stationary member or on the opening member, and
which comprises a retaining means designed to maintain the opening member in an intermediary closure position with respect to the stationary member, the retaining means being formed by an elastic tab capable of bending under the stress exerted by a first edge of the housing on a free end of the tab when the opening member moves from a free opening position to the intermediary closure position, wherein at least the free end portion which is in contact with the first edge during said movement is made of a polymeric material whereof the hardness ranges between 90 shore scale A and 60 shore scale D and whereof the tear resistance measured according to 34-1 ISO standard is higher than 70 kN/m.

2. The device according to claim 1, wherein said free end portion forms a protruding nose over a length ranging between one quarter and one half of the length of the tab.

3. The device according to claim 1, wherein said free end portion of the tab is obtained by overmolding on the tab.

4. The device according to claim 1, wherein half of the free end of the tab is made of said polymeric material by overmolding on the tab.

5. The device according to claim 1, wherein said polymeric material has a melting temperature higher than 170° C.

6. The device according to claim 1, wherein said polymeric material is selected from the group consisting of elastomers, thermoplastic and thermosetting elastomers.

7. The device according to claim 5, wherein said polymeric material is selected from the group consisting of polyurethane thermoplastic elastomers, styrenic thermoplastic elastomers and polysiloxanes.

8. The device according to claim 1, wherein the overmolding is performed by an injection, dipping or spraying method.

9. The device according to claim 1, wherein the device further comprises an abutment intended to cooperate with a second edge of the housing when the opening member moves from the free opening position to the intermediary closure position.

10. The device according to claim 1, wherein the body is extended in its area substantially corresponding to the base of the tab by a plate suspended above a recessed area, the plate and the tab being connected by an arch ensuring a flexible connection.
